(19) United States
(12) Patent Application Publication
(10) Pub. No.: US 2018/0323500 A1
(43) Pub. Date: Nov. 8, 2018

(54) MULTILEVEL ANTENNAE

(71) Applicant: Fractus, S.A., Barcelona (ES)

(72) Inventors: Carles PUENTE BALIARDA, Barcelona (ES); Carmen BORJA BORAU, Barcelona (ES); Jaume ANGUERA PROS, Vinaros (ES); Jordi SOLER CASTANY, Mataro (ES)

(21) Appl. No.: 16/035,981

(22) Filed: Jul. 16, 2018

Related U.S. Application Data
(63) Continuation of application No. 15/670,866, filed on Aug. 7, 2017, now Pat. No. 10,056,682.
Application No. 15/670,866 is a continuation of application No. 15/137,782, filed on Apr. 25, 2016, now Pat. No. 9,761,934.
Application No. 15/137,782 is a continuation of application No. 14/825,829, filed on Aug. 13, 2015, now Pat. No. 9,362,617.
Application No. 14/825,829 is a continuation of application No. 13/929,441, filed on Jun. 27, 2013, now Pat. No. 9,240,632.
Application No. 13/929,441 is a continuation of application No. 13/732,743, filed on Jan. 2, 2013, now Pat. No. 8,976,069.
Application No. 13/732,743 is a continuation of application No. 13/669,916, filed on Nov. 6, 2012, now abandoned.
Application No. 13/669,916 is a continuation of application No. 13/411,212, filed on Mar. 2, 2012, now Pat. No. 8,330,659.
Application No. 13/411,212 is a continuation of application No. 13/044,189, filed on Mar. 9, 2011, now Pat. No. 8,154,463.
Application No. 13/044,189 is a continuation of application No. 12/400,888, filed on Mar. 10, 2009, now Pat. No. 8,009,111.
Application No. 12/400,888 is a continuation of application No. 11/780,932, filed on Jul. 20, 2007, now Pat. No. 7,528,782.
Application No. 11/780,932 is a continuation of application No. 11/179,257, filed on Jul. 12, 2005, now Pat. No. 7,397,431.
Application No. 11/179,257 is a continuation of application No. 11/102,390, filed on Apr. 8, 2005, now Pat. No. 7,123,208.
Application No. 11/102,390 is a continuation of application No. 10/963,080, filed on Oct. 12, 2004, now Pat. No. 7,015,868.
Application No. 10/963,080 is a continuation of application No. 10/102,568, filed on Mar. 18, 2002, now abandoned.
Application No. 10/102,568 is a continuation of application No. PCT/ES99/00296, filed on Sep. 20, 1999.

(51) Int. Cl. H01Q 1/36; H01Q 1/24; H01Q 5/20; H01Q 5/10; H01Q 5/50; H01Q 5/40; H01Q 5/307; H01Q 1/50; H01Q 9/40; H01Q 9/28; H01Q 9/06; H01Q 9/04; H01Q 1/38; H01Q 5/357

(52) U.S. Cl. CPC H01Q 1/36; H01Q 1/241; H01Q 5/357; H01Q 5/20; H01Q 5/10; H01Q 5/50; H01Q 5/40; H01Q 5/307; H01Q 1/50; H01Q 9/40; H01Q 9/28; H01Q 9/065; H01Q 9/0407; H01Q 9/04; H01Q 1/38

(57) ABSTRACT

A multi-band antenna includes at least one structure useable at multiple frequency ranges. The structure includes at least two levels of detail, with one level of detail making up another level of detail. The levels of detail are composed of closed plane figures bounded by the same number of sides. An interconnection circuit links the multi-band antenna to an input/output connector and incorporates adaptation networks, filters or diplexers. Each of the closed plane figures is linked to at least one other closed plane figure to exchange electromagnetic power. For at least 75% of the closed plane figures, the region or area of contact, intersection, or interconnection between the closed plane figures is less than 50% of their perimeter or area. Not all of the closed plane figures have the same size, and the perimeter of the structure has a different number of sides than its constituent closed plane figures.

### CROSS REFERENCE TO RELATED APPLICATIONS

This application is a Continuation Application of U.S. patent application Ser. No. 15/670,866, filed Aug. 7, 2017, which is a Continuation Application of U.S. patent application Ser. No. 15/137,782, filed Apr. 25, 2016, now U.S. Pat. No. 9,761,934, issued on Sep. 12, 2017, which is a Continuation Application of U.S. patent application Ser. No. 14/825,829, filed Aug. 13, 2015, now U.S. Pat. No. 9,362,617, issued on Jun. 7, 2016, which is a Continuation Application of U.S. patent application Ser. No. 13/929,441, filed Jun. 27, 2013, now U.S. Pat. No. 9,240,632, issued on Jan. 19, 2016, which is a Continuation Application of U.S. patent application Ser. No. 13/732,743, filed Jan. 2, 2013, now U.S. Pat. No. 8,976,069, issued on Mar. 10, 2015, which is a Continuation Application of U.S. patent Ser. No. 13/669,916, filed Nov. 6, 2012, now abandoned, which is a Continuation Application of U.S. patent application Ser. No. 13/411,212, filed Mar. 2, 2012, now U.S. Pat. No. 8,330,659, issued on Dec. 11, 2012, which is a Continuation Application of U.S. patent application Ser. No. 13/044,189, filed on Mar. 9, 2011, now U.S. Pat. No. 8,154,463, issued on Apr. 10, 2012, which is a Continuation Application of U.S. patent application Ser. No. 12/400,888, filed on Mar. 10, 2009, now U.S. Pat. No. 8,009,111, issued on Aug. 30, 2011, which is a Continuation Application of U.S. patent application Ser. No. 11/780,932, filed on Jul. 20, 2007, now U.S. Pat. No. 7,528,782, issued on May 5, 2009, which is a Continuation Application of U.S. patent application Ser. No. 11/179,257, filed on Jul. 12, 2005, now U.S. Pat. No. 7,397,431, issued on Jul. 8, 2008, which is a Continuation Application of U.S. patent application Ser. No. 11/102,390, filed on Apr. 8, 2005, now U.S. Pat. No. 7,123,208, issued on Oct. 17, 2006, which is a Continuation Application of U.S. patent application Ser. No. 10/963,080, filed on Oct. 12, 2004, now U.S. Pat. No. 7,015,868, issued on Mar. 21, 2006, which is a Continuation Application of U.S. patent application Ser. No. 10/102,568, filed Mar. 18, 2002, entitled MULTILEVEL ANTENNAE, now abandoned, which is a Continuation Application of PCT/ES99/00296, filed on Sep. 20, 1999, the specifications of each of which are incorporated herein by reference.

### TECHNICAL FIELD

The present invention relates to antennae formed by sets of similar geometrical elements (polygons, polyhedrons electro magnetically coupled and grouped such that in the antenna structure may be distinguished each of the basic elements which form it.

More specifically, it relates to a specific geometrical design of said antennae by which two main advantages are provided: the antenna may operate simultaneously in several frequencies and/or its size can be substantially reduced.

The scope of application of the present invention is mainly within the field of telecommunications, and more specifically in the field of radio-communication.

### BACKGROUND

Antennae were first developed towards the end of the past century, when James C. Maxwell in 1864 postulated the fundamental laws of electromagnetism. Heinrich Hertz may be attributed in 1886 with the invention of the first antenna by which transmission in air of electromagnetic waves was demonstrated. In the mid forties were shown the fundamental restrictions of antennae as regards the reduction of their size relative to wavelength, and at the start of the sixties the first frequency-independent antennae appeared. At that time helixes, spirals, logoperiodic groupings, cones and structures defined solely by angles were proposed for construction of wide band antennae.

In 1995 were introduced the fractal or multifractal type antennae (Pat. No. 9,501,019), which due to their geometry presented a multifrequency behavior and in certain cases a small size. Later were introduced multitriangular antennae (Pat. No. 9,800,954) which operated simultaneously in bands GSM 900 and GSM 1800.

The antennae described in the present patent have their origin in fractal and multitriangular type antennae, but solve several problems of a practical nature which limit the behavior of said antennae and reduce their applicability in real environments.

From a scientific standpoint strictly fractal antennae are impossible, as fractal objects are a mathematical abstraction which include an infinite number of elements. It is possible to generate antennae with a form based on said fractal objects, incorporating a finite number of iterations. The performance of such antennae is limited to the specific geometry of each one. For example, the position of the bands and their relative spacing is related to fractal geometry and it is not always possible, viable or economic to design the antennae maintaining its fractal appearance and at the same time placing the bands at the correct area of the radioelectric spectrum. To begin, truncation implies a clear example of the limitations brought about by using a real fractal type antenna which attempts to approximate the theoretical behavior of an ideal fractal antenna. Said effect breaks the behavior of the ideal fractal structure in the lower band, displacing it from its theoretical position relative to the other bands and in short requiring a too large size for the antenna which hinders practical applications.

In addition to such practical problems, it is not always possible to alter the fractal structure to present the level of impedance of radiation diagram which is suited to the requirements of each application. Due to these reasons, it is often necessary to leave the fractal geometry and resort to other types of geometries which offer a greater flexibility as regards the position of frequency bands of the antennae, adaptation levels and impedances, polarization and radiation diagrams.

Multitriangular structures (Pat. No. 9,800,954) were an example of non-fractal structures with a geometry designed such that the antennae could be used in base stations of GSM and DCS cellular telephony. Antennae described in said patent consisted of three triangles joined only at their vertices, of a size adequate for use in bands 890 MHz-960 MHz and 1710 MHz-1880 MHz. This was a specific solution for a specific environment which did not provide the flexibility and versatility required to deal with other antennae designs for other environments.

Multilevel antennae solve the operational limitations of fractal and multitriangular antennae. Their geometry is much more flexible, rich and varied, allowing operation of the antenna from two to many more bands, as well as providing a greater versatility as regards diagrams, band positions and impedance levels, to name a few examples. Although they are not fractal, multilevel antennae are characterized in that they comprise a number of elements which may be distinguished in the overall structure. Precisely because they clearly show several levels of detail (that of the overall structure and that of the individual elements which make it up), antennae provide a multiband behavior and/or a small size. The origin of their name also lies in said property.

The present invention consists of an antenna whose radiating element is characterized by its geometrical shape, which basically comprises several polygons or polyhedrons of the same type. That is, it comprises for example triangles, squares, pentagons, hexagons or even circles and ellipses as a limiting case of a polygon with a large number of sides, as well as tetrahedra, hexahedra, prisms, dodecahedra, etc. coupled to each other electrically (either through at least one point of contact or through a small separation providing a capacitive coupling) and grouped in structures of a higher level such that in the body of the antenna can be identified the polygonal or polyhedral elements which it comprises. In turn, structures generated in this manner can be grouped in higher order structures in a manner similar to the basic elements, and so on until reaching as many levels as the antenna designer desires.

Its designation as multilevel antenna is precisely due to the fact that in the body of the antenna can be identified at least two levels of detail: that of the overall structure and that of the majority of the elements (polygons or polyhedrons) which make it up. This is achieved by ensuring that the area of contact or intersection (if it exists) between the majority of the elements forming the antenna is only a fraction of the perimeter or surrounding area of said polygons or polyhedrons.

A particular property of multilevel antennae is that their radioelectric behavior can be similar in several frequency bands. Antenna input parameters (impedance and radiation diagram) remain similar for several frequency bands (that is, the antenna has the same level of adaptation or standing wave relationship in each different band), and often the antenna presents almost identical radiation diagrams at different frequencies. This is due precisely to the multilevel structure of the antenna, that is, to the fact that it remains possible to identify in the antenna the majority of basic elements (same type polygons or polyhedrons) which make it up. The number of frequency bands is proportional to the number of scales or sizes of the polygonal elements or similar sets in which they are grouped contained in the geometry of the main radiating element.

In addition to their multiband behavior, multilevel structure antennae usually have a smaller than usual size as compared to other antennae of a simpler structure. (Such as those consisting of a single polygon or polyhedron). This is because the path followed by the electric current on the multilevel structure is longer and more winding than in a simple geometry, due to the empty spaces between the various polygon or polyhedron elements. Said empty spaces force a given path for the current (which must circumvent said spaces) which travels a greater distance and therefore resonates at a lower frequency. Additionally, its edge-rich and discontinuity-rich structure simplifies the radiation process, relatively increasing the radiation resistance of the antenna and reducing the quality factor Q, i.e., increasing its bandwidth.

Thus, the main characteristic of multilevel antennae are the following:
A multilevel geometry comprising polygon or polyhedron of the same class, electromagnetically coupled and grouped to form a larger structure. In multilevel geometry most of these elements are clearly visible as their area of contact, intersection or interconnection (if these exist) with other elements is always less than 50% of their perimeter.
The radioelectric behavior resulting from the geometry: multilevel antennae can present a multiband behavior (identical or similar for several frequency bands) and/or operate at a reduced frequency, which allows to reduce their size.

In specialized literature it is already possible to find descriptions of certain antennae designs which allow to cover a few bands. However, in these designs the multiband behavior is achieved by grouping several single band antennae or by incorporating reactive elements in the antennae (concentrated elements as inductors or capacitors or their integrated versions such as posts or notches) which force the apparition of new resonance frequencies. Multilevel antennae on the contrary base their behavior on their particular geometry, offering a greater flexibility to the antenna designer as to the number of bands (proportional to the number of levels of detail), position, relative spacing and width, and thereby offer better and more varied characteristics for the final product.

A multilevel structure can be used in any known antenna configuration. As a nonlimiting example can be cited: dipoles, monopoles, patch or microstrip antennae, coplanar antennae, reflector antennae, wound antennae or even antenna arrays. Manufacturing techniques are also not characteristic of multilevel antennae as the best suited technique may be used for each structure or application. For example: printing on dielectric substrate by photolithography (printed circuit technique); dieing on metal plate, repulsion on dielectric, etc.

Publication WO 97/06578 discloses a fractal antenna, which has nothing to do with a multilevel antenna being both geometries essentially different.

### BRIEF DESCRIPTION OF THE DRAWINGS

Further characteristics and advantages of the invention will become apparent in view of the detailed description which follows of a preferred embodiment of the invention given for purposes of illustration only and in no way meant as a definition of the limits of the invention, made with reference to the accompanying drawings, in which:

FIG. 1 shows a specific example of a multilevel element comprising only triangular polygons;

FIGS. 2.1 to 2.7 show examples of assemblies of multilevel antennae in several configurations: monopole (2.1), dipole (2.2), patch (2.3), coplanar antennae (2.4), horn (2.5-2.6) and array (2.7);

FIGS. 3.1 to 3.15 show examples of multilevel structures based on triangles;

FIGS. 4.1 to 4.15 show examples of multilevel structures based on parallelepipeds;

FIGS. 5.1 to 5.9 show examples of multilevel structures based on pentagons;

FIGS. 6.1 to 6.9 show examples of multilevel structures based on hexagons;

FIGS. 7.1 to 7.8 show examples of multilevel structures based on polyhedrons;

FIG. 8A-8B show an example of a specific operational mode for a multilevel antenna in a patch configuration for base stations of GSM (900 MHz) and DCS (1800 MHz) cellular telephony;

FIG. 9A-9B show input parameters (return loss on 50 ohms) for the multilevel antenna described in the previous figure;

FIGS. 10A.1, 10A.2, 10B.1 and 10B.2 show radiation diagrams for the multilevel antenna of FIG. 8A-8B: horizontal and vertical planes;

FIG. 11 shows an example of a specific operation mode for a multilevel antenna in a monopole construction for indoors wireless communication systems or in radio-accessed local network environments;

FIG. 12.1-12.2 show input parameters (return loss on so ohms) for the multilevel antenna of the previous figure; and

FIGS. 13A.1 to 13A.3 and 13B.1 to 13B.3 show radiation diagrams for the multilevel antenna of FIG. 11.

### DETAILED DESCRIPTION

In the detailed description which follows of a preferred embodiment of the present invention permanent reference is made to the figures of the drawings, where the same numerals refer to the identical or similar parts.

The present invention relates to an antenna which includes at least one construction element in a multilevel structure form. A multilevel structure is characterized in that it is formed by gathering several polygon or polyhedron of the same type (for example triangles, parallelepipeds, pentagons, hexagons, etc., even circles or ellipses as special limiting cases of a polygon with a large number of sides, as well as tetrahedra, hexahedra, prisms, dodecahedra, etc. coupled to each other electromagnetically, whether by proximity or by direct contact between elements. A multilevel structure or figure is distinguished from another conventional figure precisely by the interconnection (if it exists) between its component elements (the polygon or polyhedron). In a multilevel structure at least 75% of its component elements have more than 50% of their perimeter (for polygons) not in contact with any of the other elements of the structure. Thus, in a multilevel structure it is easy to identify geometrically and individually distinguish most of its basic component elements, presenting at least two levels of detail: that of the overall structure and that of the polygon or polyhedron elements which form it. Its name is precisely due to this characteristic and from the fact that the polygon or polyhedron can be included in a great variety of sizes. Additionally, several multilevel structures may be grouped and coupled electromagnetically to each other to form higher level structures. In a multilevel structure all the component elements are polygons with the same number of sides or polyhedron with the same number of faces. Naturally, this property is broken when several multilevel structures of different natures are grouped and electromagnetically coupled to form meta-structures of a higher level.

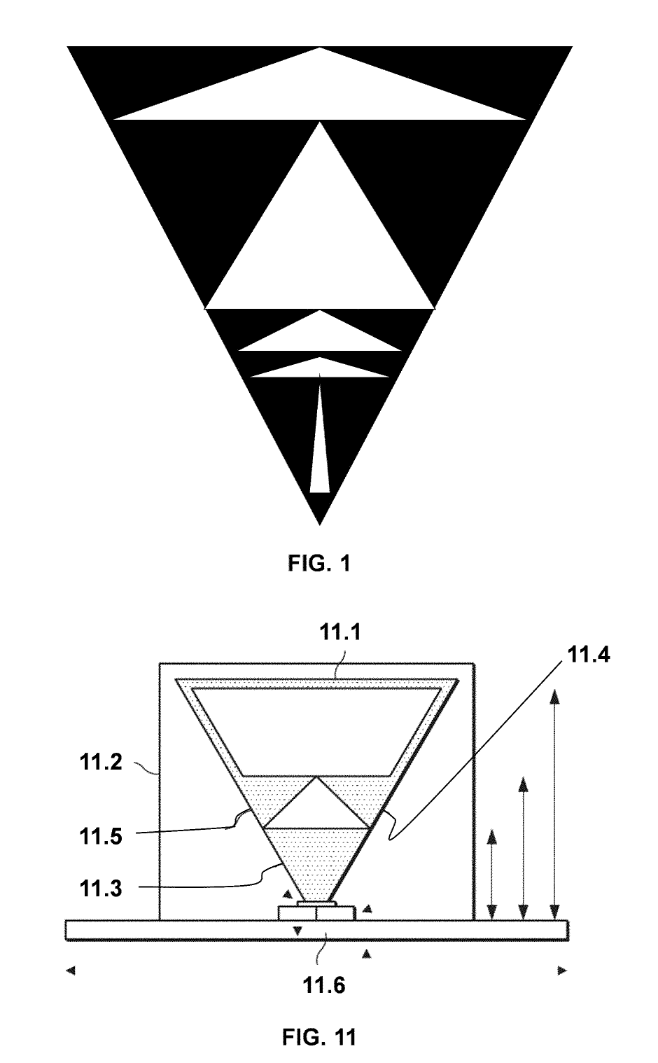

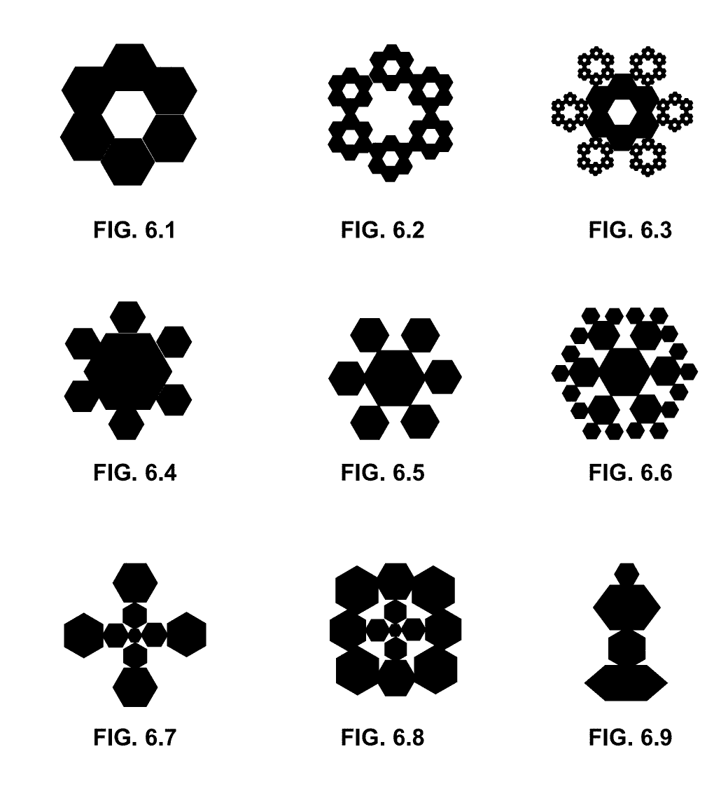

In this manner, in FIGS. 1 to 7 are shown a few specific examples of multilevel structures.

FIG. 1 shows a multilevel element exclusively consisting of triangles of various sizes and shapes. Note that in this particular case each and every one of the elements (triangles, in black) can be distinguished, as the triangles only overlap in a small area of their perimeter, in this case at their vertices.

FIGS. 2.1 to 2.7 show examples of assemblies of multilevel antennae in various configurations: monopole (21), dipole (22), patch (23), coplanar antennae (24), coil in a side view (25) and front view (26) and array (27). With this it should be remarked that regardless of its configuration the multilevel antenna is different from other antennae in the geometry of its characteristic radiant element.

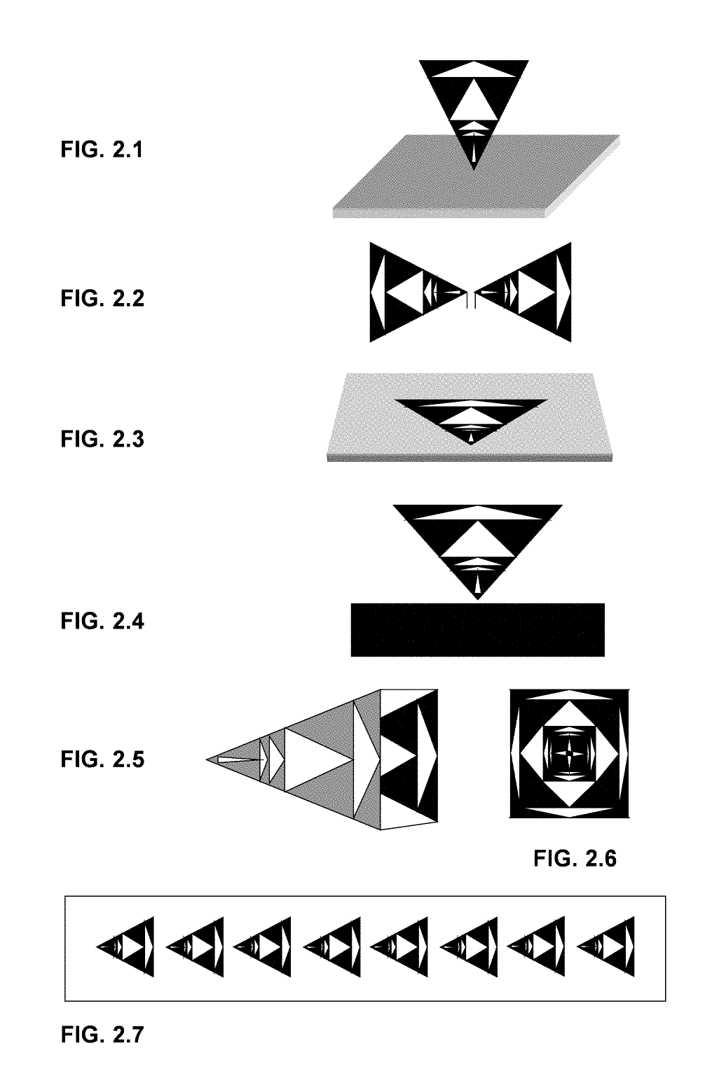

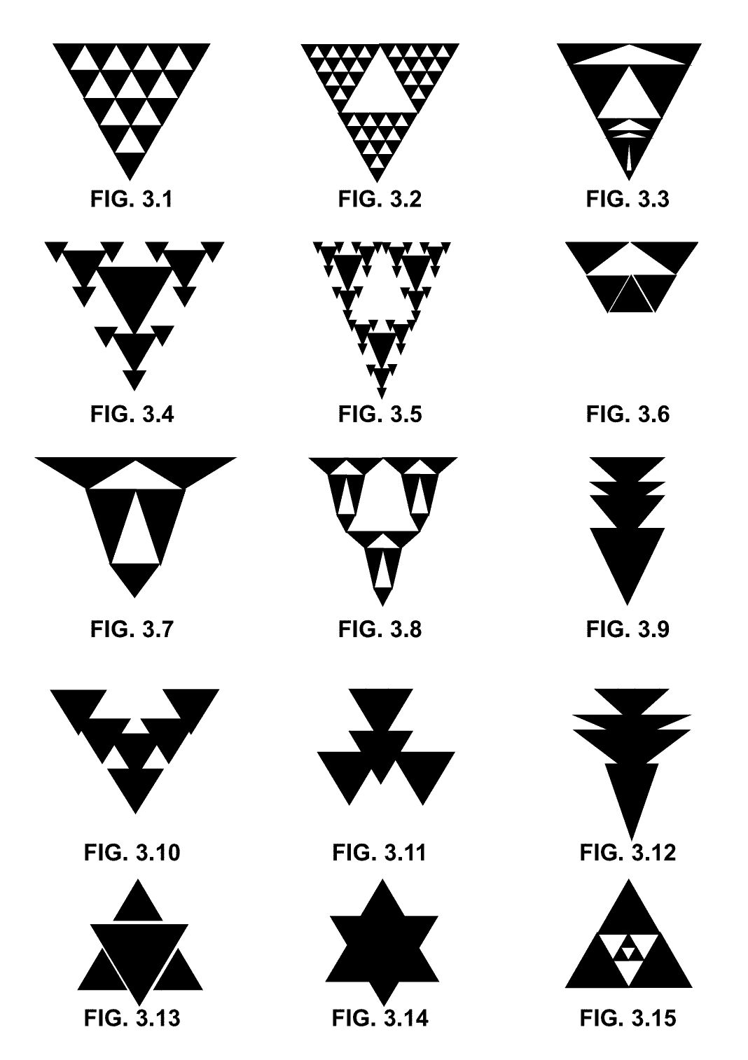

FIGS. 3.1 to 3.15 show further examples of multilevel structures with a triangular origin, all comprised of triangles. Note that case (3.14) is an evolution of case (3.13); despite the contact between the 4 triangles, 75% of the elements (three triangles, except the central one) have more than 50% of the perimeter free.

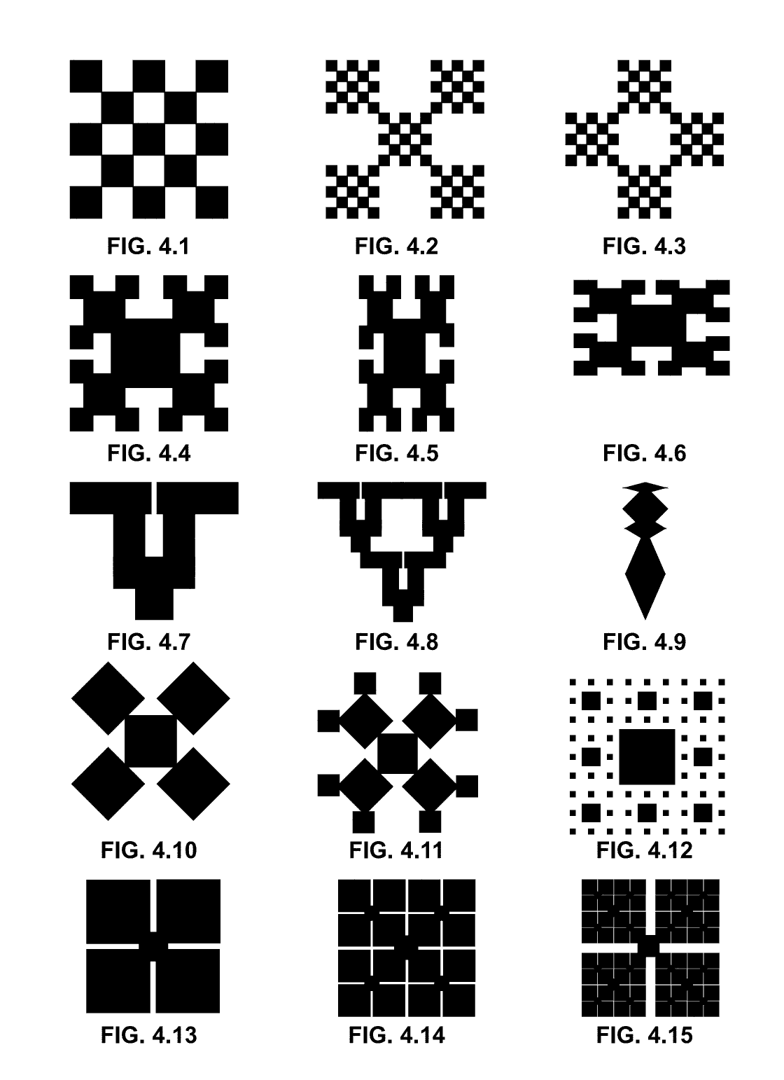

FIGS. 4.1 to 4.15 describe multilevel structures formed by parallelepipeds (squares, rectangles, rhombi . . . ). Note that the component elements are always individually identifiable (at least most of them are). In case (4.12), specifically, said elements have 100% of their perimeter free, without there being any physical connection between them (coupling is achieved by proximity due to the mutual capacitance between elements).

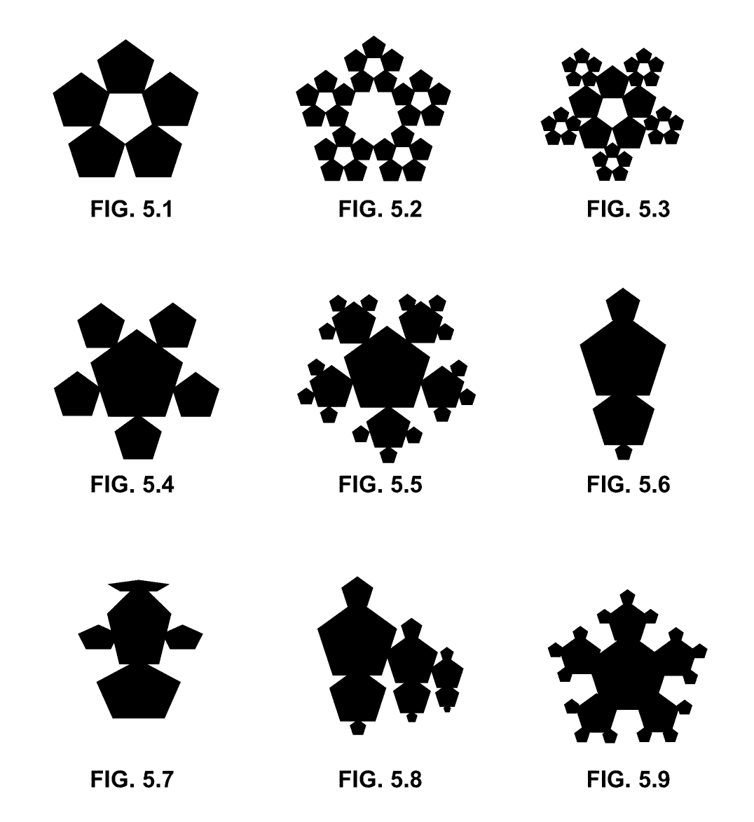

FIGS. 5.1-5.9, 6.1-6.9 and 7.1-7.8 show non-limiting examples of other multilevel structures based on pentagons, hexagons and polyhedron respectively.

It should be remarked that the difference between multilevel antennae and other existing antennae lies in the particular geometry, not in their configuration as an antenna or in the materials used for construction. Thus, the multilevel structure may be used with any known antenna configuration, such as for example and in a non-limiting manner: dipoles, monopoles, patch or microstrip antennae, coplanar antennae, reflector antennae, wound antennae or even in arrays. In general, the multilevel structure forms part of the radiative element characteristic of said configurations, such as the arm, the mass plane or both in a monopole, an arm or both in a dipole, the patch or printed element in a microstrip, patch or coplanar antenna; the reflector for an reflector antenna, or the conical section or even antenna walls in a horn type antenna. It is even possible to use a spiral type antenna configuration in which the geometry of the loop or loops is the outer perimeter of a multilevel structure. In all, the difference between a multilevel antenna and a conventional one lies in the geometry of the radiative element or one of its components, and not in its specific configuration.

As regards construction materials and technology, the implementation of multilevel antennae is not limited to any of these in particular and any of the existing or future techniques may be employed as considered best suited for each application, as the essence of the invention is found in the geometry used in the multilevel structure and not in the specific configuration. Thus, the multilevel structure may for example be formed by sheets, parts of conducting or superconducting material, by printing in dielectric substrates (rigid or flexible) with a metallic coating as with printed circuits, by imbrications of several dielectric materials which form the multilevel structure, etc. always depending on the specific requirements of each case and application. Once the multilevel structure is formed the implementation of the antenna depends on the chosen configuration (monopole, dipole, patch, horn, reflector . . . ). For monopole, spiral, dipole and patch antennae the multisimilar structure is implemented on a metal support (a simple procedure involves applying a photolithography process to a virgin printed circuit dielectric plate) and the structure is mounted on a standard microwave connector, which for the monopole or patch cases is in turn connected to a mass plane (typically a metal plate or case) as for any conventional antenna. For the dipole case two identical multilevel structures form the two arms of the antenna; in an opening antenna the multilevel geometry may be part of the metal wall of a horn or its cross section, and finally for a reflector the multisimilar element or a set of these may form or cover the reflector.

The most relevant properties of the multilevel antennae are mainly due to their geometry and are as follows: the possibility of simultaneous operation in several frequency bands in a similar manner (similar impedance and radiation diagrams) and the possibility of reducing their size compared to other conventional antennae based exclusively on a single polygon or polyhedron. Such properties are particularly relevant in the field of communication systems. Simultaneous operation in several frequency bands allows a single multilevel antenna to integrate several communication systems, instead of assigning an antenna for each system or service as is conventional. Size reduction is particularly useful when the antenna must be concealed due to its visual impact in the urban or rural landscape, or to its unaesthetic or unaerodynamic effect when incorporated on a vehicle or a portable telecommunication device.

An example of the advantages obtained from the use of a multiband antenna in a real environment is the multilevel antenna AM1, described further below, used for GSM and DCS environments. These antennae are designed to meet radioelectric specifications in both cell phone systems. Using a single GSM and DCS multilevel antenna for both bands (900 MHz and 1800 MHz) cell telephony operators can reduce costs and environmental impact of their station networks while increasing the number of users' (customers) supported by the network.

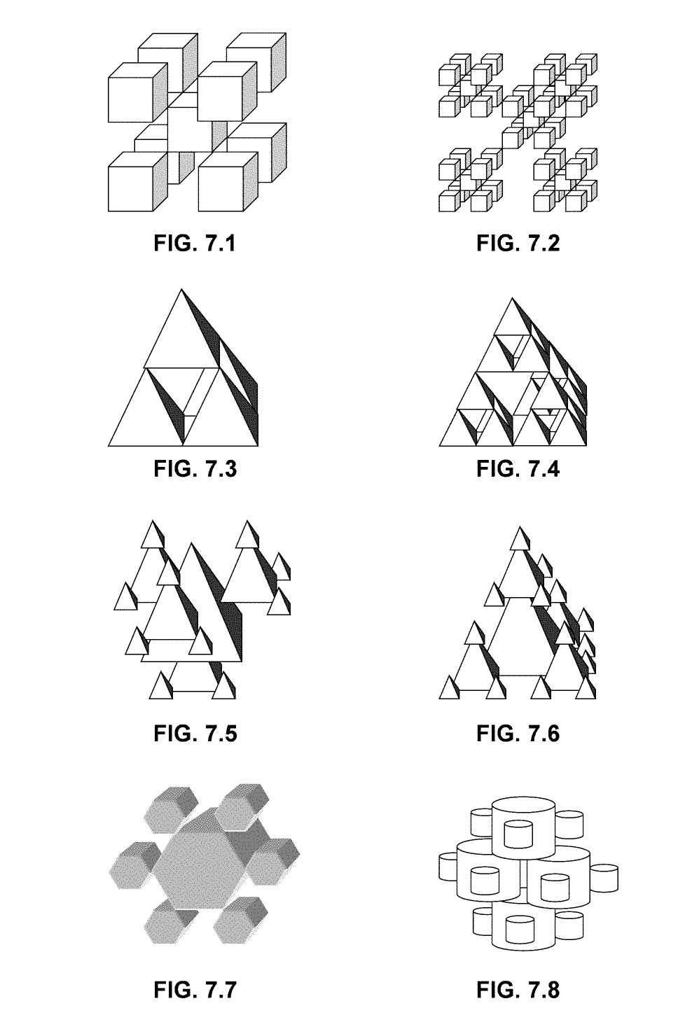

It becomes particularly relevant to differentiate multilevel antennae from fractal antennae. The latter are based on fractal geometry, which is based on abstract mathematical concepts which are difficult to implement in practice. Specialized scientific literature usually defines as fractal those geometrical objects with a non-integral Haussdorf dimension. This means that fractal objects exist only as an abstraction or a concept, but that said geometries are unthinkable (in a strict sense) for a tangible object or drawing, although it is true that antennae based on this geometry have been developed and widely described in the scientific literature, despite their geometry not being strictly fractal in scientific terms. Nevertheless some of these antennae provide a multiband behavior (their impedance and radiation diagram remains practically constant for several frequency bands), they do not on their own offer all of the behavior required of an antenna for applicability in a practical environment. Thus, Sierpinski's antenna for example has a multiband behavior with N bands spaced by a factor of 2, and although with this spacing one could conceive its use for communications networks GSM 900 MHz and GSM 1800 MHz (or DCS), its unsuitable radiation diagram and size for these frequencies prevent a practical use in a real environment. In short, to obtain an antenna which in addition to providing a multiband behavior meets all of the specifications demanded for each specific application it is almost always necessary to abandon the fractal geometry and resort for example to multilevel geometry antennae. As an example, none of the structures described in FIGS. 1, 3.1-3.15, 4.1-4.15, 5.1-5.9 and 6.1-6.9 are fractal. Their Hausdorff dimension is equal to 2 for all, which is the same as their topological dimension. Similarly, none of the multilevel structures of FIG. 7.1-7.8 are fractal, with their Hausdorff dimension equal to 3, as their topological dimension.

In any case multilevel structures should not be confused with arrays of antennae. Although it is true that an array is formed by sets of identical antennae, in these the elements are electromagnetically decoupled, exactly the opposite of what is intended in multilevel antennae. In an array each element is powered independently whether by specific signal transmitters or receivers for each element, or by a signal distribution network, while in a multilevel antenna the structure is excited in a few of its elements and the remaining ones are coupled electromagnetically or by direct contact (in a region which does not exceed 50% of the perimeter or surface of adjacent elements). In an array is sought an increase in the directivity of an individual antenna o forming a diagram for a specific application; in a multilevel antenna the object is to obtain a multiband behavior or a reduced size of the antenna, which implies a completely different application from arrays.

Below are described, for purposes of illustration only, two non-limiting examples of operational modes for Multilevel Antennae (AM1 and AM2) for specific environments and applications.

### Mode AM1

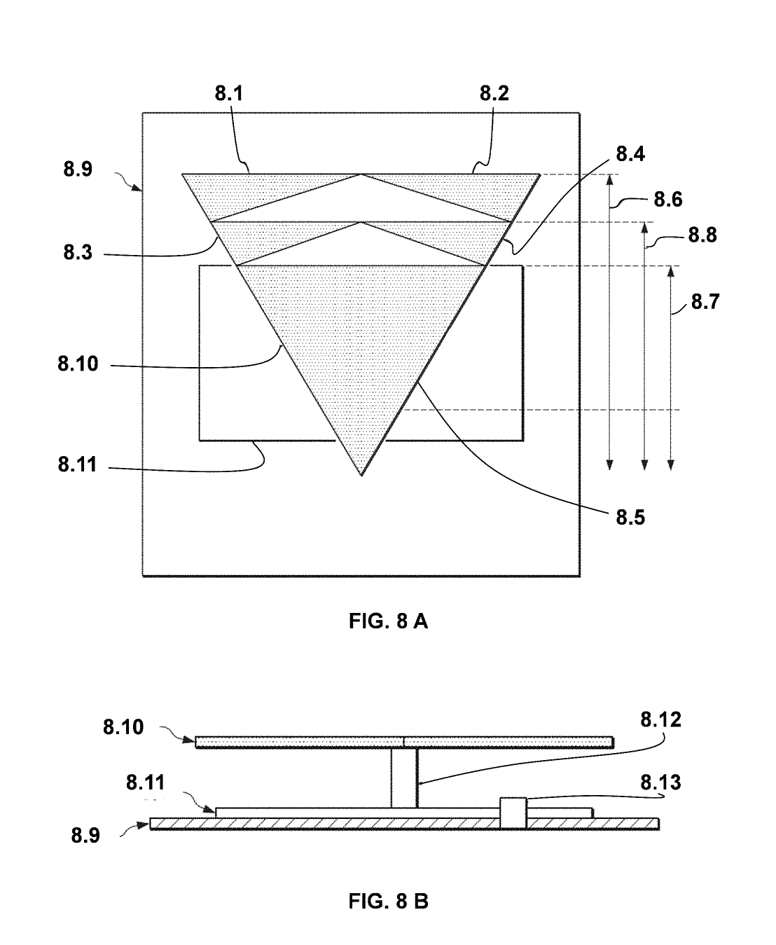

This model consists of a multilevel patch type antenna, shown in FIG. 8A-8B, which operates simultaneously in bands GSM 900 (890 MHz-960 MHz) and GSM 1800 (1710 MHz-1880 MHz) and provides a sector radiation diagram in a horizontal plane. The antenna is conceived mainly (although not limited to) for use in base stations of GSM 900 and 1800 mobile telephony.

The multilevel structure (8.10), or antenna patch, consists of a printed copper sheet on a standard fiberglass printed circuit board. The multilevel geometry consists of 5 triangles (8.1-8.5) joined at their vertices, as shown in FIG. 8A, with an external perimeter shaped as an equilateral triangle of height 13.9 cm (8.6). The bottom triangle has a height (8.7) of 8.2 cm and together with the two adjacent triangles form a structure with a triangular perimeter of height 10.7 cm (8.8).

The multilevel patch (8.10) is mounted parallel to an earth plane (8.9) of rectangular aluminum of 22. times. 18.5 cm. The separation between the patch and the earth plane is 3.3 cm, which is maintained by a pair of dielectric spacers which act as support (8.12).

Connection to the antenna is at two points of the multilevel structure, one for each operational band (GSM 900 and GSM 1800). Excitation is achieved by a vertical metal post perpendicular to the mass plane and to the multilevel structure, capacitively finished by a metal sheet which is electrically coupled by proximity (capacitive effect) to the patch. This is a standard system in patch configuration antennae, by which the object is to compensate the inductive effect of the post with the capacitive effect of its finish.

At the base of the excitation post is connected the circuit which interconnects the elements and the port of access to the antenna or connector (8.13). Said interconnection circuit may be formed with microstrip, coaxial or strip-line technology to name a few examples, and incorporates conventional adaptation networks which transform the impedance measured at the base of the post to so ohms (with a typical tolerance in the standing wave relation (SWR) usual for these application under 1.5) required at the input/output antenna connector. Said connector is generally of the type N or SMA for micro-cell base station applications.

In addition to adapting the impedance and providing an interconnection with the radiating element the interconnection network (8.11) may include a diplexor allowing the antenna to be presented in a two connector configuration (one for each band) or in a single connector for both bands.

For a double connector configuration in order to increase the insulation between the GSM 900 and GSM 1800 (DCS) terminals, the base of the DCS and excitation post may be connected to a parallel stub of electrical length equal to half a wavelength, in the central DCS wavelength, and finishing in an open circuit. Similarly, at the base of the GSM 900 lead can be connected a parallel stub ending in an open circuit of electrical length slightly greater than one quarter of the wavelength at the central wavelength of the GSM band. Said stub introduces a capacitance in the base of the connection which may be regulated to compensate the residual inductive effect of the post. Furthermore, said stub presents very low impedance in the DCS band which aids in the insulation between connectors in said band.

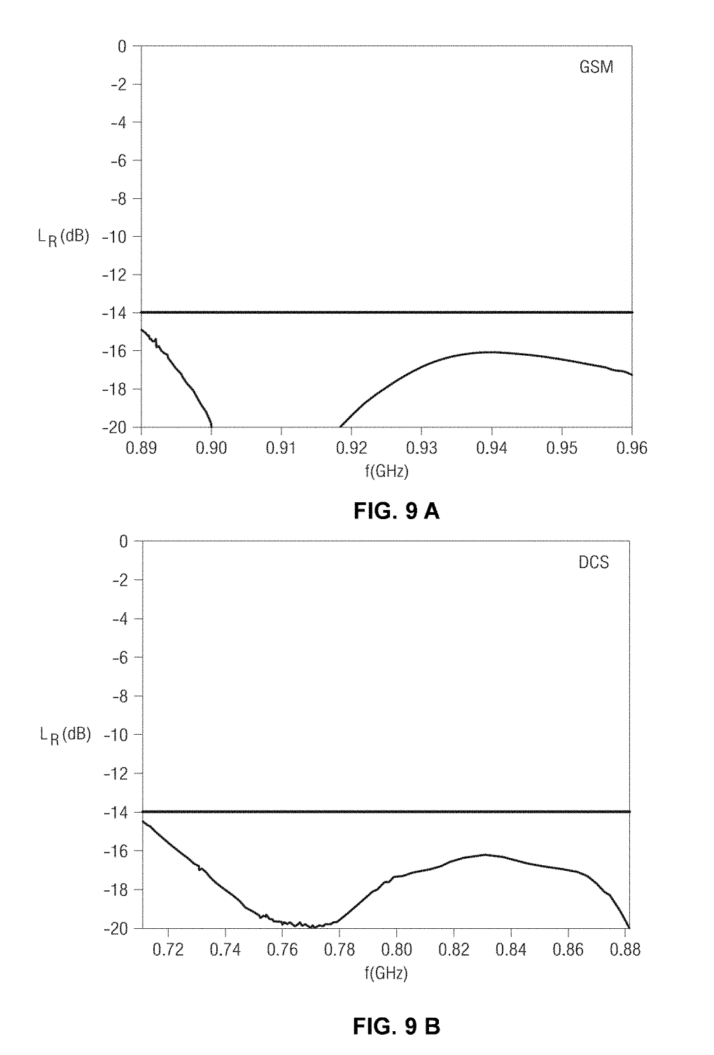

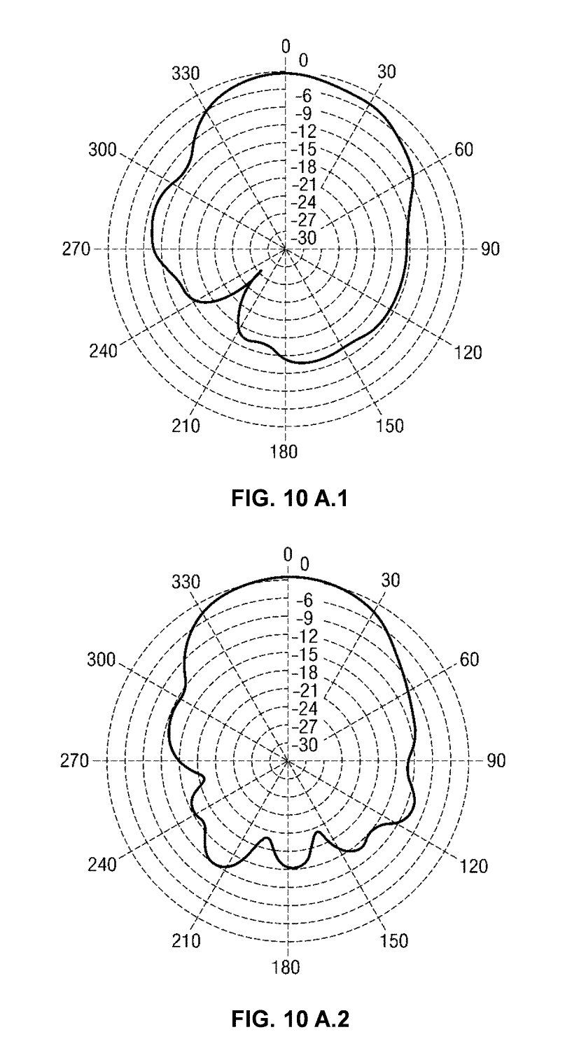

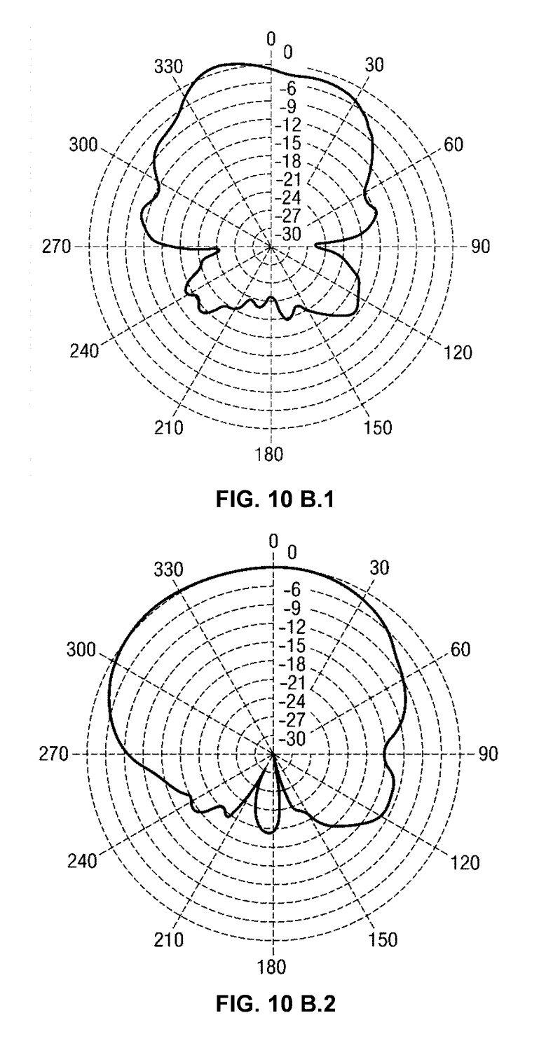

In FIGS. 9A-9B, 10A and 10B are shown the typical radioelectric behavior for this specific embodiment of a dual multilevel antenna.

FIG. 9A-9B shows return losses (Lr) in GSM (9.1) and DCS (9.2), typically under −14 dB (which is equivalent to SWR<1.5), so that the antenna is well adapted in both operation bands (890 MHz-960 MHz and 1710 MHz-1880 MHz).

Radiation diagrams in the vertical (10A.1 and 10B.1) and the horizontal plane (10A.2 and 10B.2) for both bands are shown in FIG. 10A.1, 10A.2, 10B.1 and 10B.2. It can be seen clearly that both antennae radiate using a main lobe in the direction perpendicular to the antenna (10A.1 and 10B.1), and that in the horizontal plane (10A.2 and 10B.2) both diagrams are sectorial with a typical beam width at 3 dB of 65° . Typical directivity (d) in both bands is d>7 Db.

### Mode AM2

This model consists of a multilevel antenna in a monopole configuration, shown in FIG. 11, for wireless communications systems for indoors or in local access environments using radio.

The antenna operates in a similar manner simultaneously for the bands 1880 MHz-1930 MHz and 3400 MHz-3600 MHz, such as in installations with the system DECT. The multilevel structure is formed by three or five triangles (see FIGS. 11 and 3.6) to which may be added an inductive loop (11.1). The antenna presents an omnidirectional radiation diagram in the horizontal plane and is conceived mainly for (but not limited to) mounting on roof or floor.

The multilevel structure is printed on a Rogers® RO4003 dielectric substrate (11.2) of 5.5 cm width, 4.9 cm height and 0.8 mm thickness, and with a dielectric permittivity equal to 3.38. The multilevel element consists of three triangles (11.3-11.5) joined at the vertex; the bottom triangle (11.3) has a height of 1.82 cm, while the multilevel structure has a total height of 2.72 cm. In order to reduce the total size f the antenna the multilevel element is added an inductive loop (11.1) at its top with a trapezoidal shape in this specific application, so that the total size of the radiating element is 4.5 cm.

The multilevel structure is mounted perpendicularly on a metallic (such as aluminum) earth plane (11.6) with a square or circular shape about 18 cm in length or diameter. The bottom vertex of the element is placed on the center of the mass plane and forms the excitation point for the antenna. At this point is connected the interconnection network which links the radiating element to the input/output connector. Said interconnection network may be implemented as a microstrip, strip-line or coaxial technology to name a few examples. In this specific example the microstrip configuration was used. In addition to the interconnection between radiating element and connector, the network can be used as an impedance transformer, adapting the impedance at the vertex of the multilevel element to the 50 Ohms (Lr <−14 dB, SWR<1.5) required at the input/output connector.

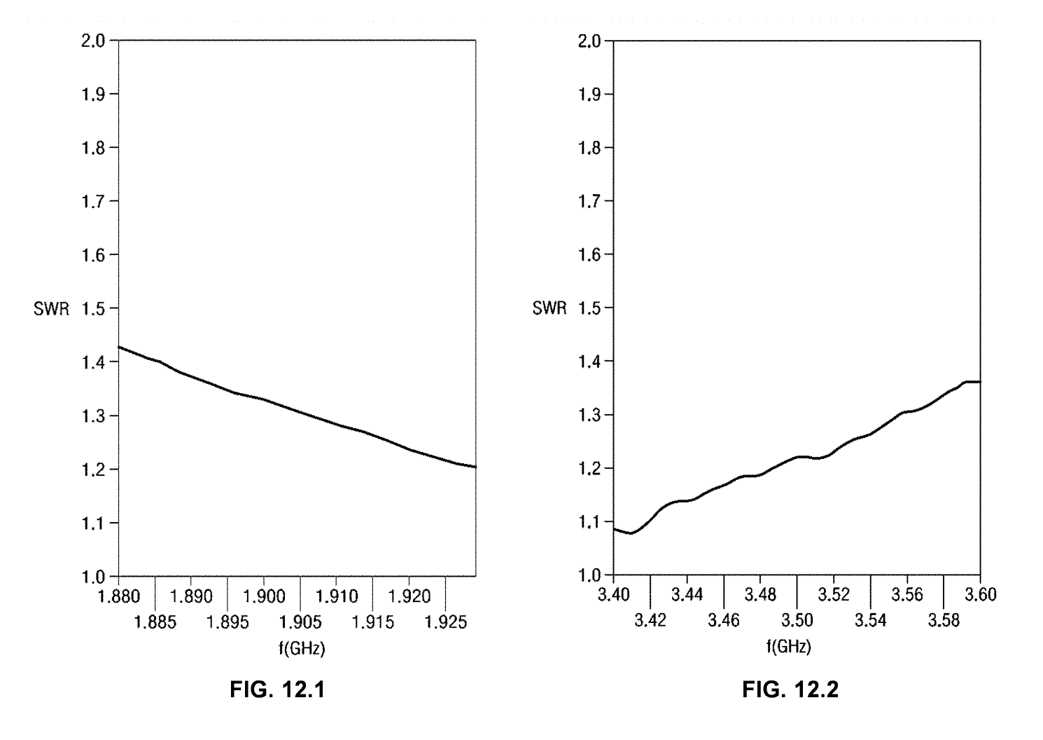

FIGS. 12.1-12.2, 13A.1-13A.3 and 13B.1-13B.3 summarize the radioelectric behavior of antennae in the lower (1900) and higher bands (3500).

FIG. 12.1-12.2 show the standing wave ratio (SWR) for both bands: FIG. 12.1 for the band between 1880 and 1930 MHz, and FIG. 12.2 for the band between 3400 and 3600 MHz. These show that the antenna is well adapted as return losses are under 14 dB, that is, SWR<1.5 for the entire band of interest.

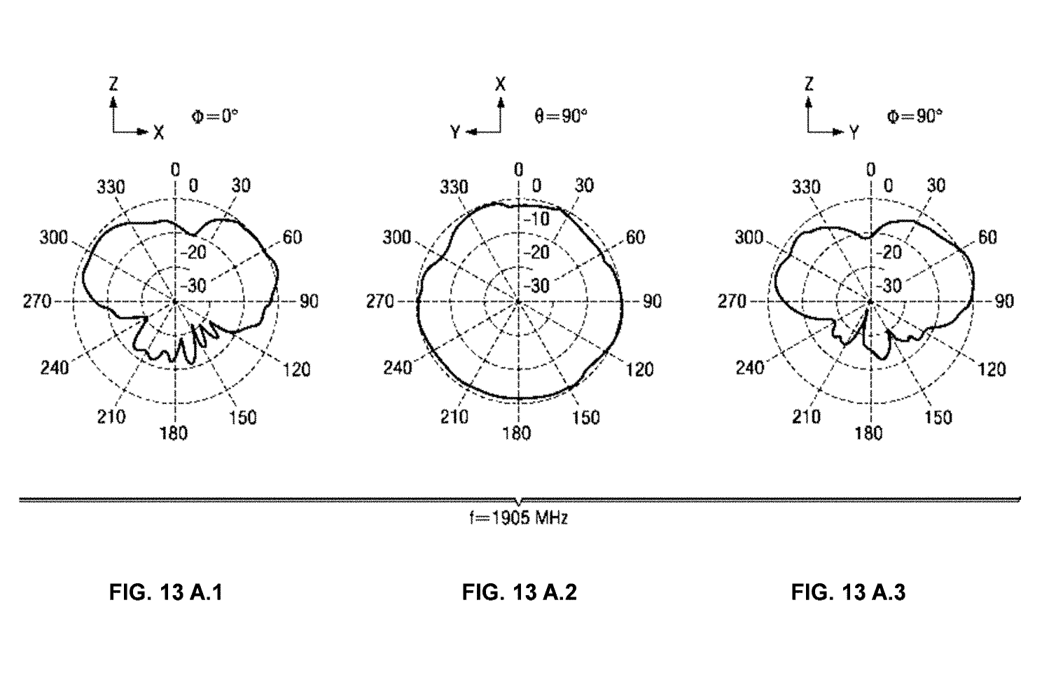

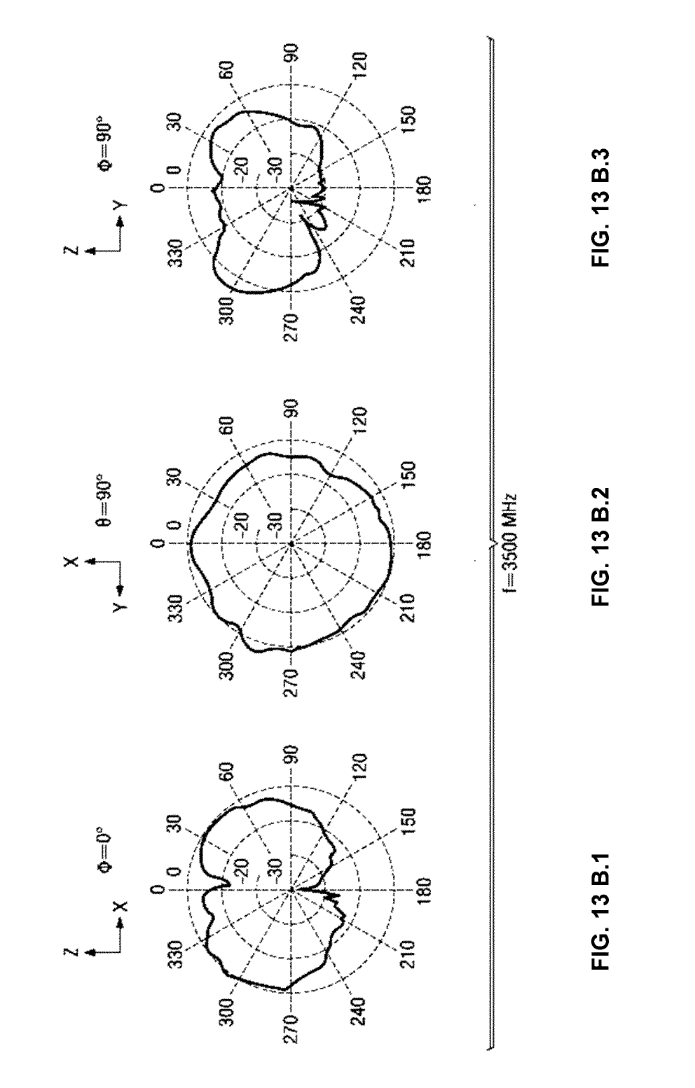

FIGS. 13A.1-13A.3 and 13B.1-13B.3 show typical radiation diagrams. Diagrams (13A.1), (13A.2) and (13A.3) at 1905 MHz measured in the vertical plane, horizontal plane and antenna plane, respectively, and diagrams (13B.1), (13B.2) and (13B.3) at 3500 MHz measured in the vertical plane, horizontal plane and antenna plane, respectively.

One can observe an omnidirectional behavior in the horizontal plane and a typical bilobular diagram in the vertical plane with the typical antenna directivity above 4 dBi in the 1900 band and 6 dBi in the 3500 band.

In the antenna behavior it should be remarked that the behavior is quite similar for both bands (both SWR and in the diagram) which makes it a multiband antenna.

Both the AM1 and AM2 antennae will typically be coated in a dielectric radome which is practically transparent to electromagnetic radiation, meant to protect the radiating element and the connection network from external aggression as well as to provide a pleasing external appearance.

It is not considered necessary to extend this description in the understanding that an expert in the field would be capable of understanding its scope and advantages resulting thereof, as well as to reproduce it.

However, as the above description relates only to a preferred embodiment, it should be understood that within this essence may be introduced various variations of detail, also protected, the size and/or materials used in manufacturing the whole or any of its parts.

What is claimed is:

1. An apparatus comprising:
an internal antenna element having a multi-band behavior, the antenna element being concealed within the apparatus and configured to operate in at least first and second non-overlapping frequency bands, the internal antenna element comprising a plurality of geometric elements, wherein:
not all of the plurality of geometric elements have the same size;
each of the plurality of geometric elements is electromagnetically coupled to at least one other of the plurality of geometric elements either directly through at least one point of contact or through a small separation providing coupling;
each of the plurality of geometric elements has the same number of sides, the perimeter of the antenna element having a different number of sides than each of the plurality of geometric elements;
a first set of the plurality of geometric elements has an area of a first size configured to operate at the first frequency band, a second set of the plurality of geometric elements has an area of a second size configured to operate at the second frequency band, the second set of geometric elements residing substantially within the first set of geometric elements;
the first and second sets of geometric elements define empty spaces in the antenna element to provide a first winding current path within the first set of geometric elements and a second winding current path within the second set of geometric elements;
the antenna element provides a substantially similar impedance level and radiation pattern in the at least the first and second frequency bands;
the plurality of geometric elements is arranged such that the antenna element does not comprise a group of single band antennas that respectively operate in the at least first and second frequency bands; and
a geometry of the antenna element is not substantially self-repeating.

2. The apparatus of claim 1, wherein the second set of geometric elements is smaller than the first set of geometric elements.

3. The apparatus of claim 2, wherein: the antenna element is configured to operate in a third frequency band; a third set of the plurality of geometric elements has an area of a third size configured to operate at the third frequency band; and the third set of geometrical elements resides entirely within at least one of the first and the second sets of geometric elements.

4. The apparatus of claim 3, wherein, for at least 75% of the plurality of geometric elements, the region of contact between the geometric elements is less than 50% of the perimeter of the geometric elements.

5. The apparatus of claim 4, wherein all of the plurality of geometric elements have four sides and at least one of the sides of at least one of the plurality of geometric elements is curved.

6. The apparatus of claim 1, wherein, for at least 75% of the plurality of geometric elements, the region of contact between the geometric elements is less than 50% of the perimeter of the geometric elements.

7. The apparatus of claim 6, wherein: the antenna element is configured to operate in at least at a third frequency band; a third set of the plurality of geometric elements has an area of a third size configured to operate in the third frequency band; and the third set of geometrical elements resides entirely within at least one of the first and second sets of geometric elements.

8. The apparatus of claim 7, wherein the antenna element provides a substantially similar impedance level and radiation pattern in the at least first, second, and third frequency bands.

9. The apparatus of claim 8, wherein the antenna element is configured to operate in at least a fourth frequency band, and wherein the antenna element provides a substantially similar impedance level and radiation pattern in the at least first, second, third, and fourth frequency bands.

10. The apparatus of claim 9, wherein all of the geometric elements have four sides and at least one of the sides of at least one of the plurality of geometric elements is curved.

11. An apparatus comprising:
an antenna having a multi-band behavior, the antenna being concealed within a portable communication device and configured to operate in at least first and second non-overlapping frequency bands, the antenna comprising an antenna element comprising a plurality of geometric elements, wherein:
not all of the plurality of geometric elements have the same size;
each of the plurality of geometric elements has the same number of sides, the antenna element having a different number of sides than each of the plurality of geometric elements;
each of the plurality of geometric elements is electromagnetically coupled to at least one other of the plurality of geometric elements either directly through at least one point of contact or through a small separation providing coupling;
for at least 50% of the plurality of geometric elements, the region of contact between the geometric elements is less than 50% of the perimeter of the geometric elements;
the antenna element provides a substantially similar impedance level and radiation pattern in the at least first and second non-overlapping frequency bands;
the plurality of geometric elements is arranged such that the antenna element does not comprise a group of single band antennas that respectively operate in the at least first and second non-overlapping frequency bands; and
wherein a geometry of the antenna element is not substantially self-repeating.

12. The apparatus of claim 11, wherein: a first set of the plurality of geometric elements has an area of a first size configured to operate at the first frequency band; a second set of the plurality of geometric elements has an area of a second size configured to operate at the second frequency band; and the second set of geometric elements resides substantially within the first set of geometric elements.

13. The apparatus of claim 12, wherein: the antenna element is configured to operate in a third frequency band; a third set of the plurality of geometric elements has an area of a third size configured to operate at the third frequency band; and the third set of geometrical elements resides entirely within at least one of the first and second sets of geometric elements.

14. The apparatus of claim 13, wherein the second set of geometric elements is smaller than the first set of geometric elements.

15. The apparatus of claim 14, wherein all of the plurality of geometric elements have four sides and at least one of the sides of at least one of the plurality of geometric elements is curved.

16. The apparatus of claim 11, wherein the antenna element is configured to operate in a third frequency band and the antenna element provides a substantially similar impedance level and radiation pattern in the at least first, second and third frequency bands.

17. The apparatus of claim 16, wherein for at least 75% of the plurality of geometric elements, the region of contact between the geometric elements is less than 50% of the perimeter of the geometric elements.

18. The apparatus of claim 17, wherein at least one of the first and second frequency bands is in a 1,710-2,170 MHz frequency range, and at least one of the first and second frequency bands is in a 800-960 MHz frequency range.

19. The apparatus of claim 18, wherein all of the plurality of geometric elements have four sides and at least one of the sides of at least one of the plurality of geometric elements is curved.

20. The apparatus of claim 19, wherein the antenna element extends beyond a single plane.
